(19) United States
(12) Patent Application Publication
(10) Pub. No.: US 2024/0332949 A1
(43) Pub. Date: Oct. 3, 2024

(54) CONTROLLER CIRCUIT

(71) Applicant: ROHM Co., LTD., Kyoto (JP)

(72) Inventors: Nozomu Koja, Kyoto (JP); Kenichi Motoki, Kyoto (JP)

(21) Appl. No.: 18/615,755

(22) Filed: Mar. 25, 2024

(30) Foreign Application Priority Data
Mar. 30, 2023 (JP) 2023-056548

(51) Int. Cl. H02H 3/24; G05F 1/46

(52) U.S. Cl. CPC H02H 3/243; G05F 1/468

(57) ABSTRACT

Provided is a controller circuit that controls an external circuit and includes a power supply terminal that receives a power supply voltage, a first undervoltage lockout circuit that compares the power supply voltage with a first detection voltage and generates a first detection signal corresponding to a result of the comparison, a regulator circuit that receives the power supply voltage to generate an internal power supply voltage and stops operating according to the first detection signal, a control circuit that receives the internal power supply voltage to operate and controls a state of the external circuit, and a second undervoltage lockout circuit that compares the power supply voltage with a second detection voltage and generates a second detection signal corresponding to a result of the comparison.

### CROSS REFERENCE TO RELATED APPLICATIONS

This application claims priority benefit of Japanese Patent Application No. JP 2023-056548 filed in the Japan Patent Office on Mar. 30, 2023. Each of the above-referenced applications is hereby incorporated herein by reference in its entirety.

### BACKGROUND

The present disclosure relates to a controller circuit that controls an external circuit.

A semiconductor integrated circuit does not operate normally if a power supply voltage drops during the operation. An undervoltage lockout (UVLO) circuit is included to prevent such a situation. The UVLO circuit compares the power supply voltage with a UVLO detection voltage and puts an internal circuit into a semi-standby state when the power supply voltage falls below the detection voltage, to prevent a malfunction.

### BRIEF DESCRIPTION OF THE DRAWINGS

FIG. 1 is a block diagram of a circuit system according to a comparative technique;

FIG. 2 is an explanatory diagram of an operation of the circuit system in FIG. 1;

FIG. 3 is a block diagram of a circuit system according to an embodiment; and

FIG. 4 is an explanatory diagram of an operation of the circuit system in FIG. 3.

### DETAILED DESCRIPTION

### Overview of Embodiments

An overview of some exemplary embodiments of the present disclosure will be described. The overview briefly describes some concepts of one or a plurality of embodiments for basic understanding of the embodiments as a preface to detailed explanation described later, and the overview does not limit the extent of the technology or the disclosure. The overview is not a comprehensive overview of all conceivable embodiments, and the overview is not intended to specify important elements of all the embodiments or to define the scope of part or all of the modes. For convenience, “one embodiment” may be used to represent one embodiment (example or modification) or a plurality of embodiments (examples or modifications) disclosed in the present specification.

A controller circuit according to one embodiment can control an external circuit. The controller circuit includes a power supply terminal that receives a power supply voltage, a first undervoltage lockout circuit that compares the power supply voltage with a first detection voltage and that generates a first detection signal corresponding to a result of the comparison, a regulator circuit that receives the power supply voltage to generate an internal power supply voltage and that stops operating according to the first detection signal, a control circuit that receives the internal power supply voltage to operate and that controls a state of the external circuit, and a second undervoltage lockout circuit that compares the power supply voltage with a second detection voltage lower than the first detection voltage and that generates a second detection signal corresponding to a result of the comparison. The control circuit controls the state of the external circuit in response to the first detection signal and stops operating according to the second detection signal.

According to this mode, the UVLO circuit for the control circuit is separately provided in addition to the main UVLO circuit, and the stop of the operation of the control circuit is delayed from that of the other circuit block. The internal power supply voltage is maintained for a while even when the regulator circuit stops in response to the first detection signal, and meantime, the control circuit can control the external circuit.

In one embodiment, the controller circuit may be a power supply controller circuit, and the control circuit may be a sequencer.

### Embodiment

The present disclosure will be described using a preferred embodiment with reference to the drawings. The same reference signs are provided to the same or equivalent constituent elements, members, and processes illustrated in the drawings, and duplicate description will appropriately be omitted. The embodiment is exemplary and not intended to limit the disclosure. All features and combinations of the features described in the embodiment may not be essential for the disclosure.

In the present specification, a “state in which a member A is connected to a member B” includes a case in which the member A and the member B are physically and directly connected as well as a case in which the member A and the member B are indirectly connected through another member that does not substantially affect their electrical connection state and that does not impair the functions and the effects obtained by coupling the two members.

Similarly, a “state in which a member C is provided between a member A and a member B” includes a case in which the member A and the member C or the member B and the member C are directly connected as well as a case in which the relevant members are indirectly connected through another member that does not substantially affect their electrical connection state and that does not impair the functions and the effects obtained by coupling the relevant members.

First, a typical controller circuit 200R including a UVLO circuit will be described as a comparative technique.

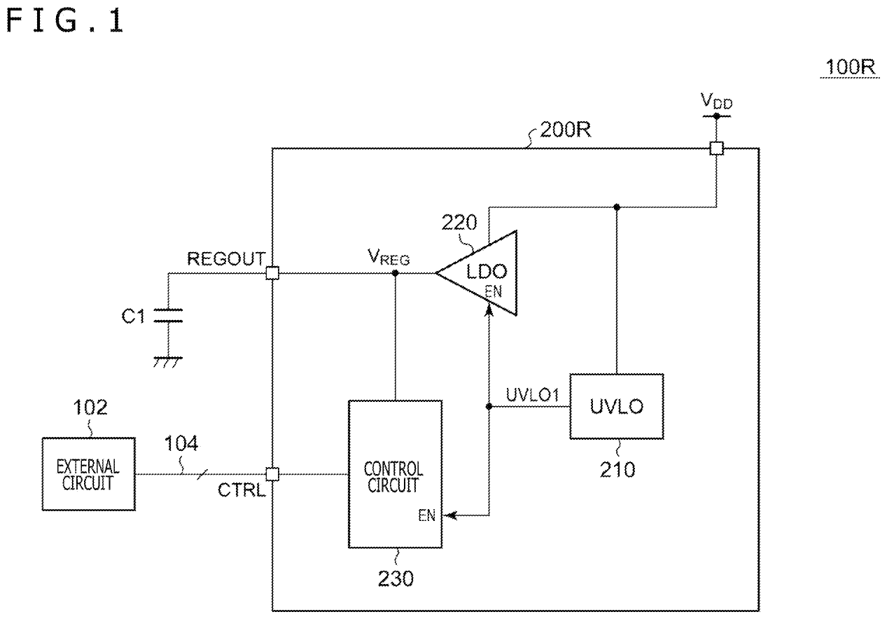

FIG. 1 is a block diagram of a circuit system 100R according to the comparative technique. The circuit system 100R includes an external circuit 102 that is a controlled circuit, and the controller circuit 200R that controls the external circuit 102. The controller circuit 200R may be an integrated circuit (IC) with a main function of controlling the external circuit 102 or may be an IC with a function of controlling the external circuit 102 in addition to other main functions.

The controller circuit 200R includes a power supply terminal VDD, a control terminal CTRL, a first UVLO circuit 210, a regulator circuit 220, and a control circuit 230. A power supply voltage V_{DD} is supplied from the outside to the power supply terminal VDD. The regulator circuit 220 receives the power supply voltage V_{DD} and generates an internal power supply voltage V_{REG} stabilized at a predetermined voltage level. An external capacitor C1 is connected to an output of the regulator circuit 220 through a regulator output terminal REGOUT.

The control circuit 230 and other circuit blocks not illustrated in FIG. 1 use the internal power supply voltage V_{REG} as a power supply to operate. The control circuit 230 and the external circuit 102 are connected through the control terminal CTRL and a control line 104. Although one control line 104 is illustrated here, the control circuit 230 and the external circuit 102 may be connected through a plurality of control lines 104. The control circuit 230 controls the electrical state of the control line 104 to control the state of the external circuit 102.

The first UVLO circuit 210 compares the power supply voltage V_{DD} with a UVLO detection voltage V_{UVLO}. When the first UVLO circuit 210 detects an undervoltage state where V_{DD}<V_{UVLO}, the first UVLO circuit 210 asserts (for example, lowers) a detection signal UVLO. The detection signal UVLO is supplied to all of the circuit blocks supposed to stop operating in the undervoltage state. The detection signal UVLO is supplied to the regulator circuit 220 and the control circuit 230 in this example.

The regulator circuit 220 and the control circuit 230 stop operating when the detection signal UVLO is asserted (lowered).

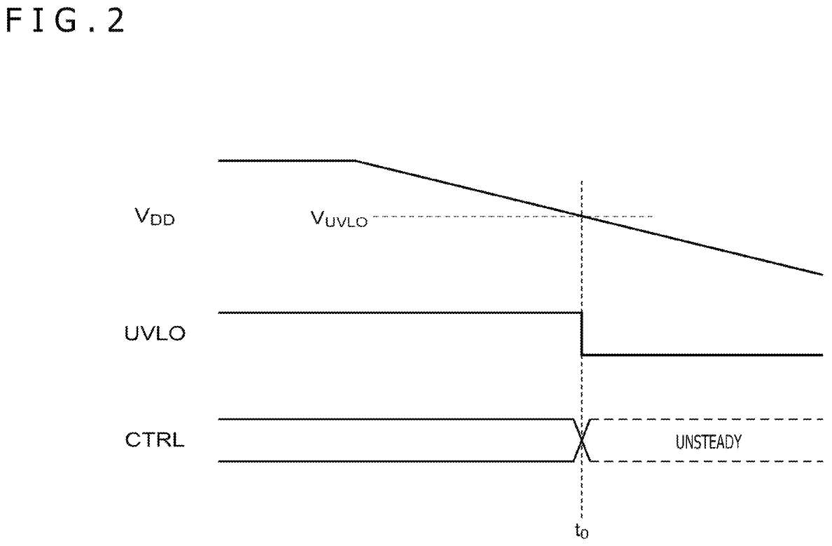

FIG. 2 is an explanatory diagram of an operation of the circuit system 100R in FIG. 1. The state is normal before time t₀, and the control circuit 230 can fix the control terminal CTRL to a certain electrical state q. When the power supply voltage V_{DD} drops and falls below the detection voltage V_{UVLO} at time t₀, the detection signal UVLO is asserted, and the control circuit 230 may find difficulty in operating. As a result, the electrical state of the control terminal CTRL becomes unsteady.

Thus, the circuit system 100R of FIG. 1 may find difficulty in shifting the state of the external circuit 102 or notifying the external circuit 102 of the undervoltage state of the controller circuit 200R when the controller circuit 200R enters the undervoltage state.

Next, a circuit system 100 according to the embodiment will be described.

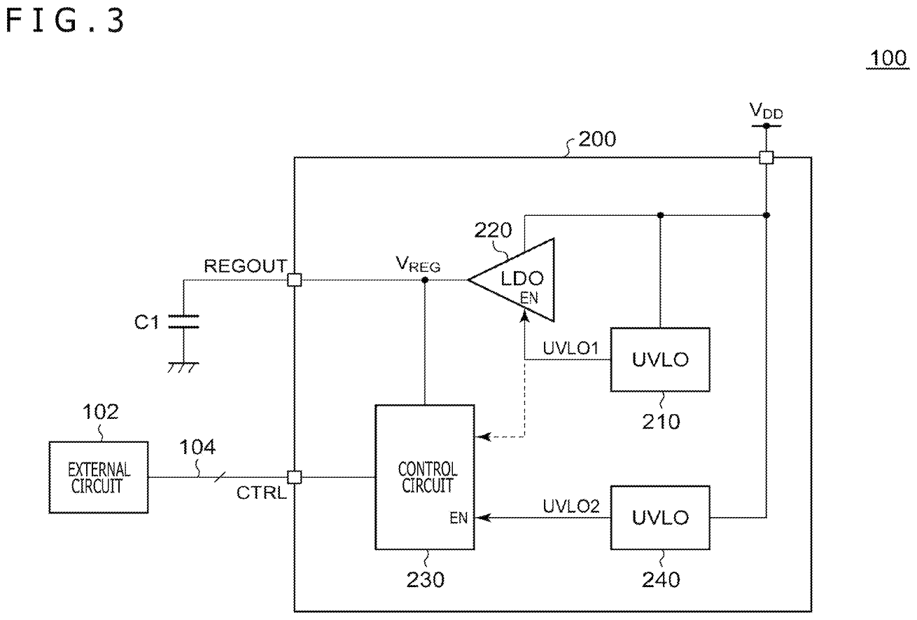

FIG. 3 is a block diagram of the circuit system 100 according to the embodiment. The circuit system 100 includes a controller circuit 200 and the external circuit 102 similarly to the circuit system 100R of FIG. 1.

The controller circuit 200 includes a second UVLO circuit 240 in addition to the UVLO circuit (referred to as a first UVLO circuit) 210, the regulator circuit 220, and the control circuit 230.

The first UVLO circuit 210, the regulator circuit 220, and the control circuit 230 are similar to those of the comparative technique.

The first UVLO circuit 210 compares the power supply voltage V_{DD} with a first detection voltage V_{UVLO1} and generates a first detection signal UVLO1. The first detection voltage V_{UVLO1} is a voltage corresponding to the detection voltage V_{UVLO} in FIG. 1 and is a threshold voltage for protecting the main parts of the controller circuit 200. The first detection signal UVLO1 is supplied to the regulator circuit 220 and other circuit blocks not illustrated. The regulator circuit 220 and the other circuit blocks not illustrated stop operating in response to the assertion of the first detection signal UVLO1.

The second UVLO circuit 240 is provided, in addition to the first UVLO circuit 210, to protect the control circuit 230. The second UVLO circuit 240 compares the power supply voltage V_{DD} with a second detection voltage V_{UVLO2} and asserts (for example, lowers) a second detection signal UVLO2 when V_{DD}<V_{UVLO2}. The second detection voltage V_{UVLO2} is set to be lower than the first detection voltage V_{UVLO1}.

The second detection signal UVLO2 is supplied to the control circuit 230. The control circuit 230 stops operating in response to the assertion of the second detection signal UVLO2.

The control circuit 230 monitors the first detection signal UVLO1, and the control circuit 230 is triggered by the assertion of the first detection signal UVLO1 to shift the state of the external circuit 102.

This completes the description of the configuration of the controller circuit 200 according to the embodiment. An operation of the controller circuit 200 will next be described.

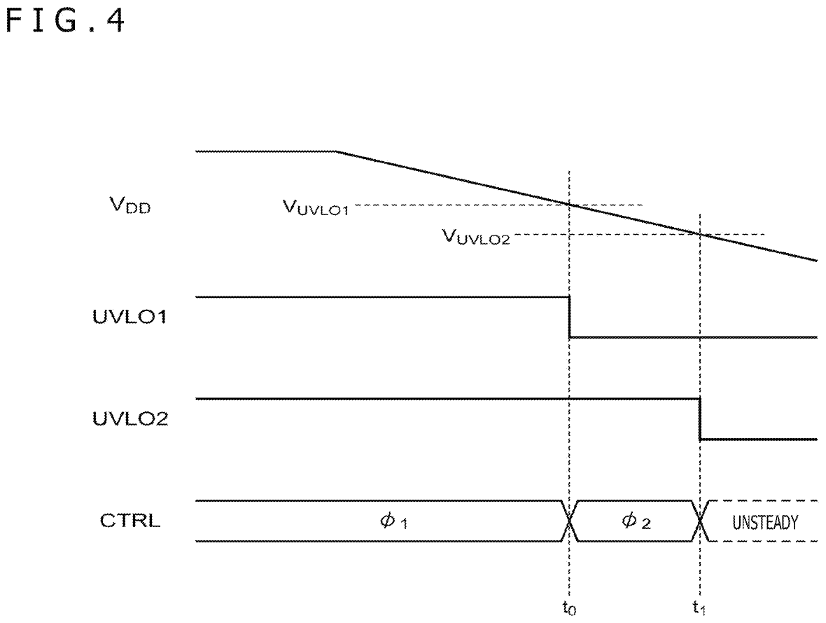

FIG. 4 is an explanatory diagram of the operation of the circuit system in FIG. 3. The state is normal before time t₀, and the control circuit 230 fixes the control terminal CTRL to a certain electrical state φ1. When the power supply voltage V_{DD} drops and falls below the first detection voltage V_{UVLO1} at time t₀, the first detection signal UVLO1 is asserted. Although the regulator circuit 220 stops in response to the assertion of the first detection signal UVLO1, the internal power supply voltage V_{REG} is maintained for a while. Meantime, the control circuit 230 shifts the control terminal CTRL to another electrical state φ2 in response to the assertion of the first detection signal UVLO1. Therefore, the state of the external circuit 102 can be shifted when the controller circuit 200 enters the undervoltage lockout state.

When the power supply voltage V_{DD} falls below the second detection voltage V_{UVLO2} at time t₁, the second detection signal UVLO2 is asserted. The control circuit 230 enters a protected state when the second detection signal VULO2 is asserted, and the electrical state of the control terminal CTRL becomes unsteady.

This completes the description of the operation of the circuit system 100. The circuit system 100 includes, in addition to the main first UVLO circuit 210, the second UVLO circuit 240 for the control circuit 230. The stop of the operation of the control circuit 230 is delayed from that of the other circuit block (220). During this extension of time, the control circuit 230 can control the external circuit 102.

The controller circuit 200 may be, for example, a power supply control circuit or a power management integrated circuit (PMIC) that controls a multi-channel power supply circuit. In this case, the control circuit 230 may be a sequencer that separately controls the operation and the stop of the multi-channel power supply circuit. The external circuit 102 may be a power supply circuit to be controlled or may be a load circuit that receives supply of power from the power supply circuit.

Although specific terms are used to describe the present disclosure based on the embodiment, the embodiment merely illustrates principles and applications of the present disclosure, and many modifications and changes in arrangement can be made in the embodiment without departing from the scope of the present disclosure defined in the claims.

### (Supplement)

The following technique is disclosed in the present specification.

### (Item 1)

A controller circuit that controls an external circuit, the controller circuit including:
a power supply terminal that receives a power supply voltage;
a first undervoltage lockout circuit that compares the power supply voltage with a first detection voltage and that generates a first detection signal corresponding to a result of the comparison;
a regulator circuit that receives the power supply voltage to generate an internal power supply voltage and that stops operating according to the first detection signal;
a control circuit that receives the internal power supply voltage to operate and that controls a state of the external circuit; and
a second undervoltage lockout circuit that compares the power supply voltage with a second detection voltage lower than the first detection voltage and that generates a second detection signal corresponding to a result of the comparison, in which
the control circuit controls the state of the external circuit in response to the first detection signal and stops operating according to the second detection signal.

### (Item 2)

The controller circuit according to item 1, in which
the controller circuit is a power supply controller circuit, and the control circuit is a sequencer.

According to the mode of the present disclosure, another circuit can be controlled when the undervoltage state is detected.

What is claimed is:

1. A controller circuit that controls an external circuit, the controller circuit comprising:
a power supply terminal that receives a power supply voltage;
a first undervoltage lockout circuit that compares the power supply voltage with a first detection voltage and that generates a first detection signal corresponding to a result of the comparison;
a regulator circuit that receives the power supply voltage to generate an internal power supply voltage and that stops operating according to the first detection signal;
a control circuit that receives the internal power supply voltage to operate and that controls a state of the external circuit; and
a second undervoltage lockout circuit that compares the power supply voltage with a second detection voltage lower than the first detection voltage and that generates a second detection signal corresponding to a result of the comparison, wherein
the control circuit controls the state of the external circuit in response to the first detection signal and stops operating according to the second detection signal.

2. The controller circuit according to claim 1, wherein
the controller circuit is a power supply controller circuit, and the control circuit is a sequencer.
